(19) United States
(12) Patent Application Publication
(10) Pub. No.: US 2024/0243303 A1
(43) Pub. Date: Jul. 18, 2024

(54) NON-UNIFORM REACTANT CHANNELS IN BIPOLAR PLATES FOR FUEL CELLS

(71) Applicant: HYDROGENICS CORPORATION, Mississauga (CA)

(72) Inventor: Salvatore RANIERI, Etobicoke (CA)

(21) Appl. No.: 18/561,586

(22) PCT Filed: Jun. 3, 2022
(86) PCT No.: PCT/CA2022/050897

§ 371 Date: Nov. 16, 2023

Related U.S. Application Data
(60) Provisional application No. 63/197,117, filed on Jun. 4, 2021.

(51) Int. Cl. H01M 8/0265; H01M 8/026; H01M 8/0267; H01M 8/241

(52) U.S. Cl. CPC H01M 8/0265; H01M 8/026; H01M 8/0267; H01M 8/241

(57) ABSTRACT

The present disclosure generally relates to a fuel cell having a membrane electrode assembly, a gas diffusion layer, and a bipolar plate. The gas diffusion layer is adjacent a side of the membrane electrode assembly. The bipolar plate is adjacent the gas diffusion layer. The bipolar plate includes more than one anode channels and more than one cathode channels.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/197,117 filed on Jun. 4, 2021, the entire disclosure of which is hereby expressly incorporated herein by reference.

### TECHNICAL FIELD

The present disclosure generally relates to systems and methods for increasing bulk reactant diffusion in anode or cathode channels and/or mitigating excess water accumulation in anode or cathode channels of a fuel cell and/or fuel cell stack.

### BACKGROUND

During fuel cell usage, water may accumulate in both the anode and in the cathode channels or flow fields towards the outlet. This is caused by the forward reactions happening within the fuel cell, causing water to form on the cathode side of the MEA. Osmotic drag from the reverse reaction of the fuel cell may cause a portion of the product water formed at the cathode side to migrate to the anode side.

Fuel cell reactant streams may be designed to operate as an open-loop configuration or a closed-loop configuration. In recent years, fuel cells have been designed to employ a closed-loop anode system with an open-loop cathode system. Unlike the excess cathode air, which is exhausted from the fuel cell stack, with an open-loop process the anode exhaust is recirculated to the inlet of the stack to form a closed-loop process. Advantages of a closed-loop anode architecture include increasing fuel utilization and a reduction of the number of components within the system specifically enabling the removal of the anode humidifier. However, the advantage of the closed-loop anode architecture can quickly become a detriment if the humidification levels exceed the tolerable level, as a cascading effect of excess water accumulation can develop.

One way to moderate or address the problem of water accumulation is to increase the excess reactant stoichiometry. This may aid in buffering excess water formation for both the anode and cathode process streams. By increasing the volumetric flow and simultaneously the velocity of the reactant supply, there would also be an increase in inertial forces that would help force any excess liquid water out of the flow fields. However, increasing the volumetric flow, the velocity, and the inertial forces comes with a consequence of additional system parasitic power losses.

An increase in excess reactant stoichiometry ratios would require the pumps that are supplying the respective gasses to work proportionally harder, which may reduce the efficiency of the overall system. Secondly, increasing the excess reactant stoichiometry would also produce a higher velocity over the entire flow field. Increasing the velocity across the entire channel or flow field is not necessary to do so since excess water generation is localized to the latter portion of the active area of the cell. Lastly, the increase in the reactant stoichiometry modifies the mass balance of the reaction, changing the thermodynamic relationships of the fuel cell which will drive further changes that may impact cell and system performance. Accordingly, described herein are systems and methods to increasing bulk reactant diffusion in anode or cathode channels and/or mitigating excess water accumulation in anode or cathode channels of a fuel cell or a fuel cell stack.

### SUMMARY

Embodiments of the present invention are included to meet these and other needs.

In an aspect, described herein is a fuel cell comprising a membrane electrode assembly, a gas diffusion layer on a first side of the membrane electrode assembly, and a metal bipolar plate comprising more than one anode channels and more than one cathode channels next to the gas diffusion layer. A fuel flows through the more than one anode channels and an oxidant flows through the more than one cathode channels, and a depth of the more than one anode channels or more than one cathode channels changes along a length of the fuel cell or fuel cell stack.

In an embodiment, the depth of the more than one anode channels changes in a direction of the flow of the fuel.

In an embodiment, the depth of the more than one anode channels changes against a direction of the flow of the fuel. In some embodiments, the depth of the more than one cathode channels changes in a direction of the flow of the oxidant. In other embodiments, the depth of the more than one cathode channels changes against a direction of the flow of the oxidant. In some other embodiments, the depth of the more than one cathode channels changes against a direction of the flow of the oxidant.

In an embodiment, the depth of the more than one anode channels, or more than one cathode channels is inclined towards the membrane electrode assembly. In some embodiments, the depth of the more than one anode channels, or more than one cathode channels is inclined by using one or more shims, standoffs, or spacers. In other embodiments, the sum of the depth of the more than one anode channels and corresponding depth of the more than one cathode channels is constant across the fuel cell and/or fuel cell stack.

In another aspect, described herein is a method of operating a fuel cell stack comprising operating a plurality of fuel cells comprising a membrane electrode assembly, a gas diffusion layer on a first side of the membrane electrode assembly, and a metal bipolar plate. The metal bipolar plate is configured to be next to the gas diffusion layer that is configured to be next to the membrane electrode assembly. The method further comprises flowing a fuel through more than one anode channels and an oxidant through more than one cathode channels of the metal bipolar plate, and decreasing water accumulation in the more than one anode channels or more than one cathode channels, wherein a depth of the more than one anode channels or more than one cathode channels changes along a length of the fuel cell stack.

In an embodiment, the method further comprises operating the fuel cell stack by increasing the diffusion of the fuel and the oxidant at the gas diffusion layer. In some embodiments, the depth of the more than one anode channels changes in a direction of the flow of the fuel. In other embodiments, the depth of the more than one anode channels changes against a direction of the flow of the fuel. In some other embodiments, the depth of the more than one cathode channels changes in a direction of the flow of the oxidant.

In an embodiment, the depth of the more than one cathode channels changes against a direction of the flow of the oxidant. In some embodiments, the depth of the more than one anode channels or more than one cathode channels is inclined towards the membrane electrode assembly. In other embodiments, the depth of the more than one anode channels or more than one cathode channels is inclined by using one or more shims, standoffs, or spacers.

In an embodiment, the sum of the depth of the more than one anode channels and corresponding depth of the more than one cathode channels is constant across the fuel cell stack.

### BRIEF DESCRIPTION OF THE DRAWINGS

FIG. 1 is a schematic of a fuel cell system including multiple fuel cell modules, each fuel cell module having one or more fuel fell stacks.

FIG. 2 is an exploded view showing a repeating unit of a fuel cell stack for use in a fuel cell module.

FIG. 3 is a schematic showing anode, cathode and coolant channels within the flow fields in a fuel cell stack.

FIG. 4 is a schematic showing an inlet header, the flow field, and an exhaust header (e.g., output) in a fuel cell stack.

FIG. 5A is a schematic showing reactant flow in an inline configuration.

FIG. 5B is a schematic showing reactant flow in a constantly crossed configuration.

FIG. 5C is a schematic showing reactant flow in a zig-zagged configuration.

FIG. 5D is a schematic showing reactant flow in a combination of in-line and crossed flow configuration.

FIG. 6A is a schematic of a bipolar plate.

FIG. 6B is a schematic showing a view along a horizontal axis of a bipolar plate.

FIG. 6C is a schematic showing a view along a longitudinal axis of the middle of a grooved section of a bipolar plate where the anode and cathode channel or flow fields are parallel or in line to each other.

FIG. 6D is a schematic showing a view along a longitudinal axis of the middle of a grooved section of of a bipolar plate where there is a decrease in the channel or flow field depth in the direction of the fuel flow.

FIG. 7A is an image showing one embodiment of a bipolar plate comprising deformations or bends within a crystal structure.

FIG. 7B is an image showing a different embodiment of a bipolar plate comprising deformations or bends within a crystal structure.

These and other features, aspects, and advantages of the present invention will become better understood when the following detailed description is read with reference to the accompanying drawings described herein. Reference is also made to the accompanying drawings that form a part hereof and in which is shown by way of illustration specific embodiments in which the invention may be practiced. These embodiments are described in sufficient detail to enable those skilled in the art to practice what is claimed and it is to be understood that other embodiments may be utilized and that logical, mechanical, and electrical changes may be made without departing from the spirit and scope of the claims. The following detailed description is, therefore, not to be taken in a limiting sense.

### DETAILED DESCRIPTION

The present disclosure is directed to systems and methods used to vary the cross-sectional area of a fuel cell flow field channel or pathway (“channel”) to increase bulk reactant (e.g., fuel, oxidant) diffusion from the channel to the gas diffusion layer (GDL). In addition, the present disclosure is related to systems and methods to mitigate excess water accumulation during prolonged periods of high current density operation of a fuel cell, stack, and/or system.

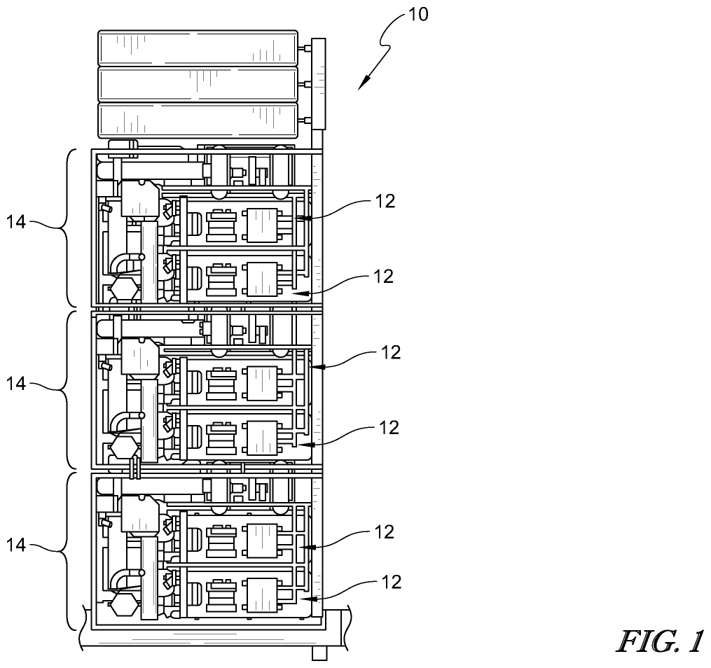

Fuel cell systems 10 may include fuel cell stacks 12 comprising a plurality of individual fuel cells 100. Each fuel cell stack 12 may house a plurality of fuel cells 100 connected together in series and/or in parallel. The fuel cell system 10 may include one or more fuel cell modules 14 as shown in FIG. 1. Each fuel cell module 14 may include a plurality of fuel cell stacks 12.

The fuel cells 100 in the fuel cell stacks 12 may be stacked together to multiply the voltage output of a single fuel cell 100. The number of fuel cells 100 in a fuel cell stack 12 can vary depending on the amount of power required to operate the fuel cell system 10 including the fuel cell stack 12. For example, the number of fuel cells 100 in each fuel cell stack 12 may range from about 200 fuel cells to about 800 fuel cells, including any specific number or range of number of fuel cells comprised therein. The fuel cells 100 in the fuel cell stacks 12 within the fuel cell module 14 may be oriented to optimize the efficiency and functionality of the fuel cell system 10.

The fuel cells 100 in the fuel cell stacks 12 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a phosphoric acid fuel cell (PAFC), or a solid oxide fuel cell (SOFC). In an exemplary embodiment, the fuel cells 100 may be a polymer electrolyte membrane or proton exchange membrane (PEM) fuel cell.

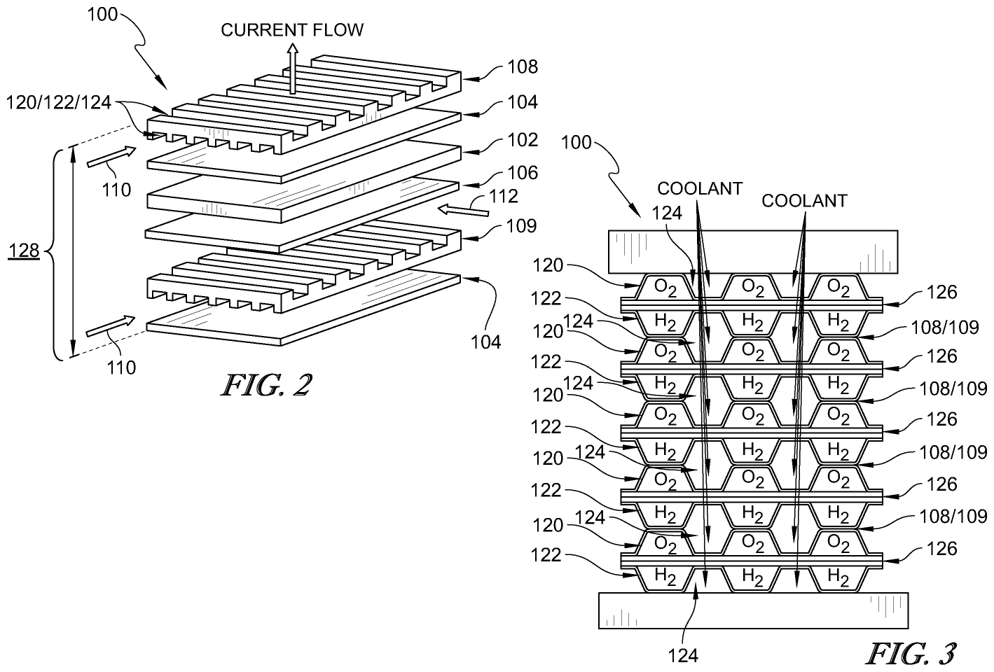

In one embodiment, the fuel cell stack 12 includes a plurality of proton exchange membrane (PEM) fuel cells 100. As shown in FIG. 2, each fuel cell 100 includes a single membrane electrode assembly (MEA) 102 and a gas diffusion layer (GDL) 104, 106 on either or both sides of the membrane electrode assembly (MEA) 102. The fuel cell 100 further includes a bipolar plate (BPP) 108, 109 on the external side of each gas diffusion layers (GDL) 104, 106. The bipolar plate (BPP) 108, 109 are responsible for the transport of reactants 110, 112 and cooling fluid in a fuel cell 100. The bipolar plate (BPP) 108, 109 can uniformly distribute reactants 110, 112 to an active area 126 of each fuel cell 100 through oxidant flow fields 120 and/or the fuel (e.g., hydrogen) flow fields 122. The active area 126, where the electrochemical reactions occur to generate power produced by the fuel cell 100, is centered within the gas diffusion layer (GDL) 104, 106 and the bipolar plate (BPP) 108, 109. The bipolar plate (BPP) 108, 109 can isolate or seal the reactants 110, 112 within their respective pathways and maintain electrically conductivity and robustness.

The fuel cell system 10 described herein, may be used in a vehicle and/or a powertrain. A vehicle comprising the present fuel cell system 10 may be an automobile, a pass car, a bus, a truck, a train, a locomotive, an aircraft, a light duty vehicle, a medium duty vehicle, or a heavy duty vehicle. The vehicle and/or a powertrain may be used on roadways, highways, railways, airways, and/or waterways. The vehicle may be used in applications including but not limited to off highway transit, bobtails, and/or mining equipment. The fuel cell system 10 may be implemented by powertrains used in stationary equipment, immovable power system, and/or electrolyzers.

FIG. 2 illustrates a repeating unit 128 of a fuel cell 100, such as a proton exchange membrane (PEM) fuel cell. This embodiment of the fuel cell 100 comprises a single membrane electrode assembly (MEA) 102. The fuel cell 100 also comprises one or more gas diffusion layers (GDL) 104, 106 on either or both sides of the MEA. The fuel cell 100 also comprises a bipolar plate (BPP) 108, 109 on the exterior and/or external side of each GDL 104, 106. As shown in FIG. 2, the repeating unit 128 includes, from top to bottom, one BPP 109, a first GDL 104, one MEA 102, and a second GDL 106.

The single repeating unit 128 of the fuel cell 100 produces a voltage output. Multiple repeating units 128 may be stacked together, such as in a fuel cell system or module, to multiply the voltage output of a single fuel cell 100 by the number of fuel cells 100 stacked together. For example, a fuel cell stack may have from about 10 to about 500 fuel cells, from about 40 to about 100 fuel cells, from about 100 to about 200 fuels cells, from about 200 to about 300 fuels cells, or from about 300 to about 400 fuels cells, including every number of fuel cells 100 comprised therein.

In an embodiment, the cross-sectional area of the fuel cell 100 and/or fuel cell stack may determine the current operating range of the fuel cell 100 and/or fuel cell stack. In some embodiments, the product of the number of fuel cells 100 comprised in a fuel cell stack and the area of each fuel cell 100 may indicate an overall power rating of the fuel cell stack. The membrane electrode assembly (MEA) 102 and the gas diffusion layer (GDL) 104, 106 may also impact the power rating of the fuel cell stack.

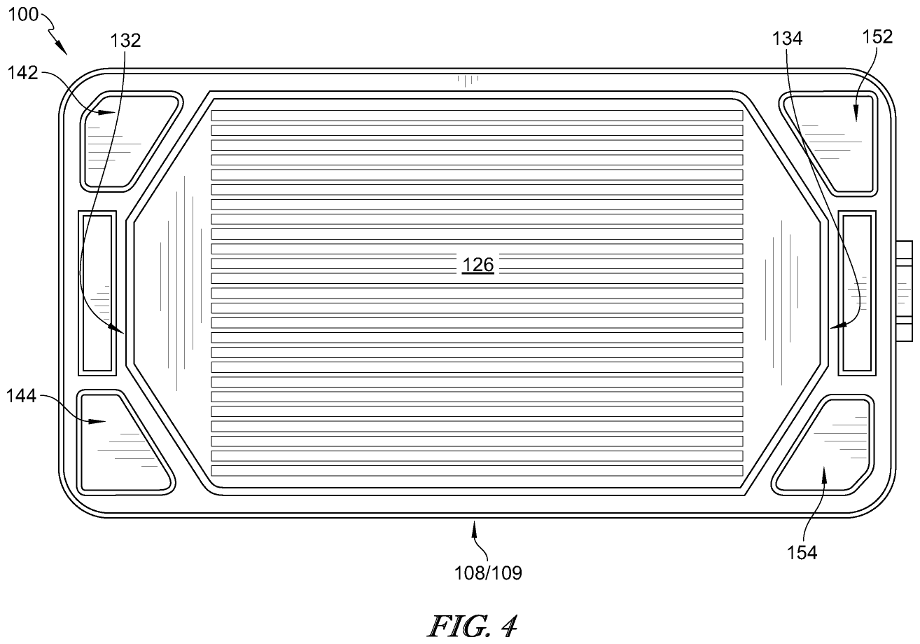

In the embodiment shown in FIGS. 2-4, the bipolar plate (BPP) 108, 109 is responsible for the transport of reactants 110, 112 and temperature regulating (e.g., cooling) fluid in the fuel cell 100. As shown in FIG. 3, in a fuel cell 100 and/or fuel cell stack, the BPP 108, 109 may be responsible for uniformly distributing reactants 110, 112 to an active area 126 of each fuel cell 100 through oxidant flow fields 120 and/or the fuel (e.g., hydrogen) flow fields 122. The active area 126, where electrochemical reactions occur to generate power produced by the fuel cell 100, may be centered within the GDL 104, 106 and the BPP 108, 109. In other embodiments, the BPP 108, 109 may be responsible for isolating or sealing the reactants 110, 112 within their respective pathways, all while being electrically conductive and robust.

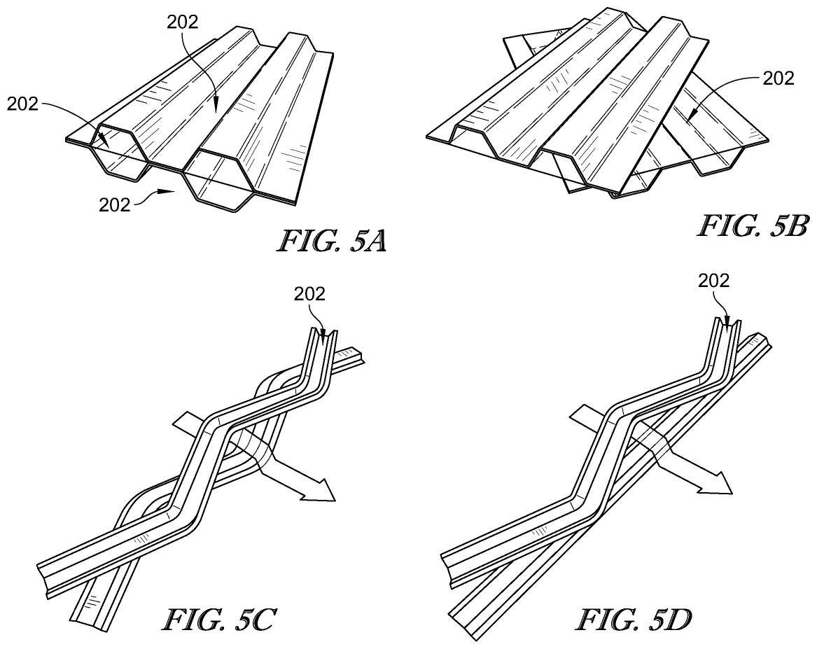

The active area 126 may also have a lead-in or header region before and/or after the MEA 102. For example, the header region may ensure better distribution over the MEA 102. In a further embodiment, as shown in FIG. 4, a fuel cell and/or fuel cell stack may have an inlet header 132 and/or an outlet header 134 as the header regions.

Referring back to FIG. 2, a fuel cell 100 and/or fuel cell stack may be supplied with an oxidant (e.g., atmospheric air, oxygen, humidified air) 110 at the cathode side. A fuel cell 100 and/or fuel cell stack that is supplied with an oxidant 110 may provide the necessary reactant to generate power. For example, a fuel cell comprising an oxidant may be subject to a chemical reaction on the cathode side of the MEA 102 represented as follows:

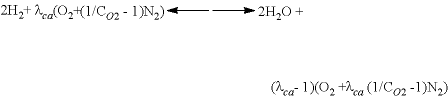

In an embodiment, the active area 126 of the fuel cell 100 is the area where the MEA 102 resides within each repeating unit 128. When liquid water begins to form over the active area 126, it may be repelled by the hydrophobic GDL 104, 106 and attracted to the more hydrophilic BPP 108, 109 surface. In an embodiment, the water may be pushed by the incoming oxidant 110 towards the exit and be ejected out of the fuel cell and/or fuel cell stack 100. In other embodiments, the water may be generated faster than the oxidant 110 is able to expel the water towards the fuel cell and/or fuel cell stack 100 exit.

In an embodiment, if water was to accumulate for a prolonged period in the fuel cell 100 and/or fuel cell stack, the fuel cell 100 exit may become blocked. Blockage of the fuel cell 100 may cause several issues related to fuel cell and/or fuel cell stack starvation of reactants 110, 112 from low stoichiometric ratios when the fuel cell 100 is unable to meet its excess fuel ratio requirement. In some embodiments, extreme cases of liquid water generation could saturate the hydrophobic GDL 104, 106 and may cause aggressive MEA 102 degeneration due to water reacting with the sensitive catalyst layers.

In an embodiment, a fuel cell 100 and/or fuel cell stack may be supplied with fuel (e.g., hydrogen) 112 at the anode. A fuel cell 100 and/or fuel cell stack that is supplied with fuel 112 may provide the necessary reactant to generate power. A fuel cell 100 and/or fuel cell stack that is supplied fuel 112 or hydrogen may be subject to a chemical reaction on the anode side of the MEA 102 represented as follows:

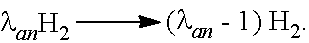

In an embodiment, water may be present both at the anode and cathode side of the fuel cell 100 and/or fuel cell stack. Water accumulation may be caused by reactions happening within the fuel cell 100 and/or fuel cell stack at the cathode, anode, and/or osmotic drag from such reactions. Such water accumulation may affect the performance of the fuel cell 100 by altering the flow fields 120, 122.

Referring to FIG. 3, in some embodiments, a change in geometry of the cathode channels or flow fields 120 and/or the anode channel or flow fields 122 may allow or enable localized fluid acceleration to better mitigate probable water accumulation. In an embodiment, the velocity of the flow of reactants 110, 112 (e.g., oxygen, air, fuel) may vary with the cross-sectional area of the anode and/or cathode channels or flow fields 120, 122. For example, in some embodiments, the velocity of the flow of reactants 110, 112 may be locally increased by reducing the size of the channels or flow field 120, 122 in the direction of reactant flow.

In other embodiments, a change in geometry of the anode and/or cathode channels or flow fields 120, 122 may be achieved by decreasing the width of the channels or flow field 120, 122. In other embodiments, a change in geometry of the anode and/or cathode channels 120, 122 or flow field may be accomplished by decreasing the height of the channels or flow field 120, 122. In some further embodiments, the change in geometry of the anode and/or cathode channels or flow field 120, 122 may be conducted by decreasing the width and/or decreasing the height (e.g., depth) of the channel or flow field 120, 122.

In an embodiment, in a fuel cell 100 and/or fuel cell stack, the BPP 108, 109 may be responsible for effectively removing any products and remaining reactants 110, 112 from the active area 126. In some embodiments, the MEA 102 may be fed excess fuel 112 and/or oxidant 110 to ensure adequate reactant supply over the entire active area 126. Excess fuel 112 and/or oxidant 110 may also be removed from the active area 126 of the MEA 102.

In other embodiments, as the reactants 110, 112 flow across the reacting site or the active area 126, there may be a change in their composition. The BPP 108, 109 may need to account for this change in the reactants 110, 112. For example, in some embodiments, the BPP 108, 109 may have an increased ability to transport the reacting molecules from, across, and/or over the active area 126 and away from the MEA 102 after the reaction has taken place.

In an embodiment, in a fuel cell 100 and/or fuel cell stack, the BPP 108, 109 may provide mechanical support to prevent the fuel cell 100 and/or fuel cell stack from bursting when pressurized. In other embodiments, in a fuel cell 100 and/or fuel cell stack, the BPP 108, 109 may provide rigidity for compressing and/or sealing the fuel cell 100 and/or the fuel cell stack, such as to provide an inherent and/or intrinsic seal of the fuel cell 100. In some other embodiments, one or more external seals (not shown) may be comprised by the fuel cell 100. These sealing mechanisms isolate the oxidant 110, fuel 112, and/or cooling fluids (e.g., coolant) to their respective flow field pathways 120, 122, 124 and/or prevent their leakage externally.

In an embodiment, the oxidant flow fields 120, the fuel flow fields 122, and the cooling fluid (coolant) flow fields 124 may be in any configuration, such as parallel or non-parallel to each other. In some embodiments, each fuel cell 100 and/or fuel cell stack may have one or more, many, multiple, or a plurality of the oxidant flow fields 120, the fuel flow fields 122, and the cooling fluid (coolant) flow fields 124. For example, in an embodiment, a fuel cell 100 may have a BPP 108, 109 that houses a network of flow fields that consist about 10 to about 100 flow fields, comprising any number or range of flow fields comprised therein. In another embodiment, a fuel cell 100 may have a total of about 20 to about 40, about 40 to about 60, about 60 to about 100 flow fields, comprising any number or range of flow fields comprised therein.

In an embodiment shown in FIG. 2, a BPP 108, 109 may be made of any number of sheets, including one, two, or more sheets. For example, a bipolar plate (BPP) 108, 109 may comprise about 2 sheets.

Each sheet may comprise a material. The material of the BPP 108, 109 may be any electrically conductive materials, such as metal or graphite. In an exemplary embodiment, the material of the BPP 108, 109 is metal.

The material of the metal BPP 108, 109 may be about 20% to about 100% metal, including any percentage or range of percentages of metal comprised therein. Typically, a sheet of a metal BPP 108, 109 may comprise about 50% to about 100% metal, including any percentage or range of percentage of metal comprised therein. In an exemplary embodiment, the sheet of the metal BPP 108, 109 may comprise about 50% to about 100% metal, including any percentage or range of percentage of metal comprised therein. In another embodiment, the sheet of the metal BPP 108, 109 may comprise about 90% to about 100% metal, including any percentage or range of percentage of metal comprised therein.

As described below, the material and structure of the metal BPP 108, 109 is important to the conductivity of the fuel cell 100 or fuel cell stack. In some embodiments, the material of the BPP 108, 109 is graphite. In other embodiments, the material of the BPP 108, 109 is not graphite. Similarly, the material of the BPP 108, 109 may or may not be any similar or different powder-based product that may be prepared by an impregnation and/or solidifying process, such as graphite. Graphite and other such materials of the BPP 108, 109 do not have the capacity to retain the necessary strength to support a fuel cell 100 or fuel cell stack without maintaining a certain minimum width or thickness. However, metal as a material of the BPP 108, 109 has considerably lower limitations.

The metal of the BPP 108, 109 may be any type of electrically conductive metal, including but not limited to austenitic stainless steel (304L, 316L, 904L, 310S), ferritic stainless steel (430, 441, 444, Crofer), Nickel based alloys (200/201, 286, 600, 625), titanium (Grade 1, Grade 2), or aluminum (1000 series, 3000 series). Exemplary metals comprised by the metal BPP 108, 109 may be steel, iron, nickel, aluminum, and/or titanium, or combinations thereof.

The sheets of the metal BPP 108, 109 may be sealed, welded, stamped, structured, bonded, and/or configured to provide the flow fields for the fuel cell fluids (e.g., two, three, or more fluids). One or more sheets of the metal BPP 108, 109 are configured to be in contact, to overlap, to be attached, or connected to one another in order to provide the flow fields for the fuel cell fluids.

One or more sheets of the metal BPP 108, 109 may be coated for corrosion resistance using any method known in the art (e.g., spraying, dipping, electrochemically bathing, adding heat, etc.). In some embodiments, the coatings may be metal based and include, but not limited to, elements such as zinc, chromium, nickel, gold, platinum, and various alloys or combinations thereof. In other embodiments, the coatings may be a graphite based coating that protects, reduces, delays, and/or prevents the BPP from corroding (e.g., rusting, deteriorating, etc.). Since graphite has the inability to oxidize, it may be advantageous to coat the metal of the BPP 108, 109 with a graphite.

In an embodiment, as shown in FIG. 4, a first sheet of the metal BPP 108, 109 may comprise indentations to produce the channels or flow fields for the cathode and/or anode 120, 122. A sheet of metal BPP 108, 109 may also include one or more distribution header regions 132, 134 for the surrounding fluid ports. For example, the metal BPP 108, 109 may comprise an inlet header region 132 and an outlet or exhaust header region 134, as shown in FIG. 4.

In some embodiments, one or more sheets of the metal BPP 108, 109 may also comprise ports or manifolds 142, 144, 152, 154. There may be any total number of ports or manifolds 142, 144, 152, 154 in the metal BPP 108, 109. For example, in an embodiment there may be about 2 to about 6 ports or manifolds 142, 144, 152, 154 in total, including any number or range of ports or manifolds comprised therein. The ports or manifolds may be any combination of inlet and outlet ports or manifolds. In an exemplary embodiment, a metal BPP 108, 109 may comprise about 6 ports or manifolds (e.g., an inlet and outlet for three fluids).

Specifically, in some exemplary embodiments, the ports or manifolds 142, 144, 152, 154 may include an individual inlet port and/or an exhaust port for the fuel, oxidant, and/or cooling fluid. In some embodiments, there may be multiple ports or manifolds 142, 144, 152, 154 surrounded by a gasket (e.g., a solid gasket) forming one set of sealed ports with enhanced strength. In other embodiments, there may be about 2 to about 6 sets of ports or manifolds 142, 144, 152, 154 in total, including any number or range of ports comprised therein.

In an embodiment, a second sheet of the metal BPP 108, 109 with a similar type of construction but with an opposite reactant port may be sealed, welded, affixed, bolted, and/or bonded to the first sheet. For example, in an embodiment of the first sheet, the fuel or oxidant may enter a port and/or a header from the top right and exit from the bottom left. In an embodiment of the second sheet, fuel or oxidant may enter a port and/or a header from the top left and exit from the bottom right. In some embodiments, the metal BPP 108, 109 may act both as the anode and cathode of two neighboring fuel cells 100 of a fuel cell stack. In an embodiment shown in FIGS. 2 and 4, the sheets may be designed, prepared, and/or manufactured in a way that results in a parallel array of corrugated channels or flow fields with one or more walls and an open face.

Typically, the flow fields 120, 122, 124 may comprise three walls and an open face. The multiple walls and open face of each flow field 120, 122, 124 may form peaks and troughs. Peaks are the high or raised portions of the flow fields 120, 122, 124, while troughs are the low or lowered portions of the flow fields 120, 122, 124.

In some embodiments, a coolant channel or flow field 124 may be aligned next to the anode channel or flow field surface 122. This coolant channel or flow field 124 may comprise about one half-channel of the coolant channel or flow field 124 and one half coolant volume in one repeating unit 128. In some embodiments, the cathode channel or flow fields 120 may be configured to be similar to the anode channel or flow field 122 with or without structural differences to account for oxidant handling rather than hydrogen handling or the handling of other fuels.

In some embodiments, the second half-channel of the coolant channel or flow field 124 and of the coolant volume in one repeating unit 128 may be comprised in a coolant channel of flow field 124 that is aligned with the cathode channel or field 120. In some embodiments, when assembled next to each other the coolant half-channels may become unified to comprise the entire coolant channel 124. In some embodiments, the coolant channel 124 may comprise the volume that is not utilized by the fuel (hydrogen) or oxidant channels or flow fields.

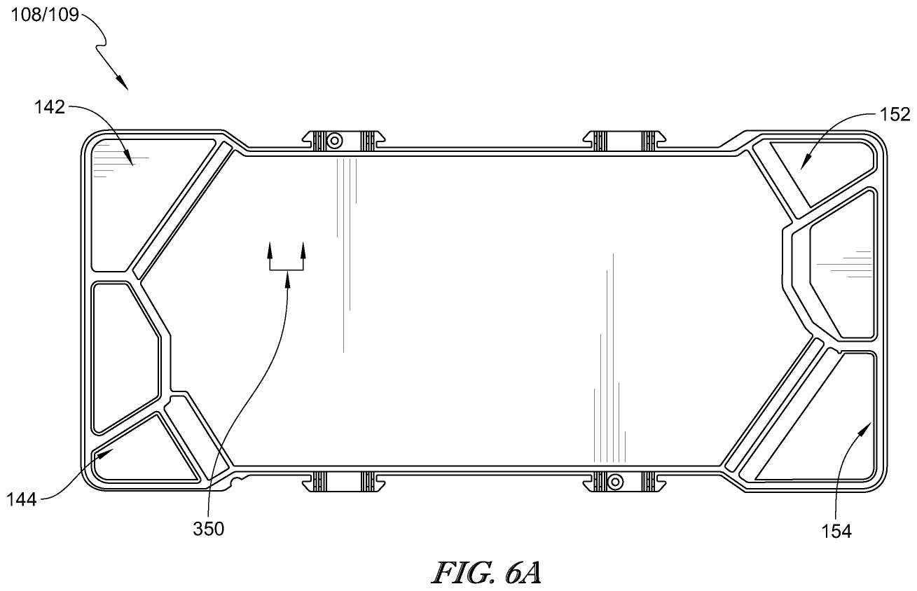

In an embodiment, the reactants 110, 112 (e.g., air, oxygen, and fuel) and coolant may flow in one of many configurations. In some embodiments, as shown in FIG. 5A, the reactants 110, 112 may flow in an inline configuration, such that the reactants 110, 112 flow in approximately straight and/or parallel lines. In other embodiments, as shown in FIG. 5B, the reactants 110, 112 may flow in a constantly crossed configuration such that the reactants 110, 112 flow in such a way that the oxidant, the fuel, and the coolant cross each other in any angle lower than a 90° angle. In some further embodiments, as shown in FIG. 5C, the reactants 110, 112 may be flow in a zig-zagged configuration, such that the reactants 110, 112 flow cross over each other multiple times. In other embodiments, as shown in FIG. 5D, the reactants 110, 112 may flow in a configuration that is a combination of in-line and crossed flow, such that a first reactant flows in an approximately straight line while a second reactant flow crosses over the first reactant flow multiple times.

In an embodiment, the one or more channels or flow fields 120, 122 comprise a flow region 202. The flow region 202 is the space, area, and/or volume in each channel or pathway where the oxidant 110 or the fuel 112 flow through the metal BPP 108, 109 of the fuel cell 100. Similarly, the flow region 202 comprises the space, area, and/or volume where the coolant flows through its channels or flow fields 124 of the metal BPP 108, 109 of the fuel cell 100.

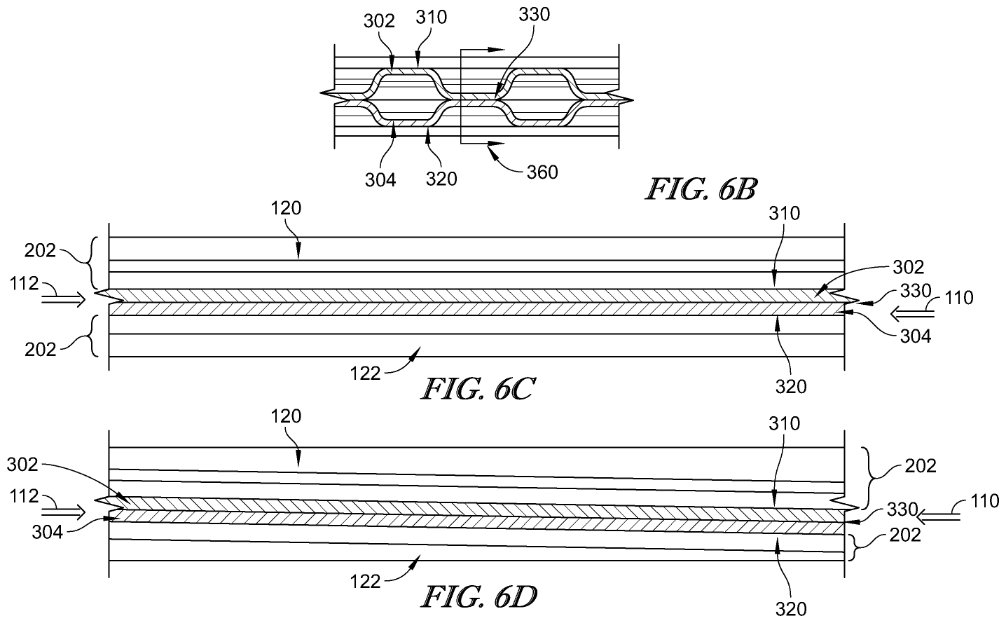

Referring to FIGS. 6A-6D, FIG. 6B shows a view along the axis 350 of a BPP 108, 109 shown in FIG. 6A. FIGS. 6C-6D are cross sectional views of the middle of the grooved section of a BPP 108, 109 along an axis 360. The flow region 202 of each anode or cathode flow fields 120, 122 may be parallel to each other as shown in FIG. 6C. In a separate embodiment, the flow region 202 of each anode or cathode flow fields 120, 122 may also be configured to include an inclination or declination between two sheets (e.g., a first sheet 302 and a second sheet 304), as shown in FIG. 6D. The inclination or declination may be on a plane 310 of a peak of the flow field 202 on a first sheet 302 and on a plane 320 of a peak of the flow field 202 on a second sheet 304. The first sheet 302 and the second sheet 304 may be configured together at a structure within a plane 330 (e.g., a structural plane) to form one or more flow regions 202 of a BPP 108, 109.

In particular, the flow region 202 of adjacent and/or adjoining flow fields 120, 122 may be configured to include the structural plane 330 having an inclination or declination. In some embodiments, the angle and/or depth of the inclination or declination of the structural plane 330 of the flow region 202 in the flow field 120 may be identical and opposite to the angle and/or depth of the inclination or declination of the flow region 202 in the flow field 122.

In an embodiment, as shown in FIG. 6D, the flow fields 120, 122 comprising the structural plane 330 may further comprise a change in the height or depth of the flow region 202. A change in the channel or flow field 120, 122 depth or height may be constant or not, and may decline and/or decrease the flow region 202 in the same direction of the fuel flow (indicated by the arrows of 112), particularly from an inlet toward an outlet. In contrast, a change in the channel or flow field 120, 122 height or depth may decline and/or decrease the flow region 202 in the same direction of the oxidant flow (indicated by the arrows of 110) from an inlet toward an outlet.

The change in the geometry of the channel or flow field 120, 122 may be achieved with an equal and opposite planar deflection on both anode and cathode flow fields 120, 122. The declination in the structural plane 330 of the channel or flow field 120, 122 in the direction of the reactant flow also results in a decrease in the flow region 202 and an increase in the flow velocity of the reactant. Similarly, a groove depth of the channel or flow field 120, 122 may also decrease, such that the channel or flow field 120, 122 may be inclined towards the structural plane 330 of the BPP 108, 109 where the first sheet 302 and second sheet 304 are configured together.

In some embodiments, the planar deflection (e.g., declination and/or inclination) of the structural plane 330 of the flow region 202 and/or the flow fields 120, 122 may be configured with any conceivable mathematical relationship from start to end. For example, in some embodiments the planar declination and/or inclination of the structural plane 330 of the flow region 202 and/or the flow fields 120, 122 may include, but is not limited to a linear, parabolic, periodic, logarithmic, and/or sinusoidal relationship. In some embodiments, more than one relationship may be used to produce the planar declination and/or inclination of the structural plane 330 of the flow region 202 and/or the flow fields 120, 122. In other embodiments, the start and the end of the deflection of the structural plane 330 may be initiated at any point within the fuel cell active area 126.

In an embodiment, the channels or flow fields 120, 122 on one BPP 108, 109 may be paired with the exact feature on an opposite BPP 108, 109. In an embodiment, including an inclination in one or more channels or flow fields 120, 122 may narrow one or more channels or flow fields 120, 122 and/or widen the corresponding channels or flow fields 120, 122. In other embodiments, the channels or flow fields 120, 122 are not widened, such that the width and/or thickness of the channels or flow fields 120, 122 are not changed or manipulated at all.

In some embodiments, such configurations may be used for a counter-flow arrangement for reactant flow from anode to cathode, as the imposed channel or flow field 120, 122 depth may provide a reduced cross sectional area in the appropriate direction for both reactants 110, 112 flow simultaneously. In other embodiments, such configurations may be used for a parallel flow arrangement from anode to cathode. In some embodiments, the anode and cathode slope may depend on or be impacted or influenced by the use of spacers. Spacers may include standoffs or shims, for example.

In an embodiment, the total height of the anode and/or cathode across a BPP 108, 109, comprising a planar declination and/or inclination of the flow region 202 of the flow field 120 and the flow region 202 of the flow field 122, may be retained. The constant height of the sum of the anode and cathode is important to maintain contact (e.g., contact maintenance) between the bottoms of the channel or flow field 120, 122 in the BPP 108, 109 with the GDL 106. Importantly, the strength and rigidity (e.g., ability to support and transfer static load without deformation) of the metal material of the BPP 108, 109 enables contact maintenance in order to ensure minimal contact resistance and adequate GDL compression to best support the electrochemical reaction of the fuel cell 100 for generating power efficiently.

For example, fuel cell and/or fuel cell stacks require high compression through the BPP 108, 109 and through the entire fuel cell and/or fuel cell stack to perform effectively. The tight connection or contact provided by the metallic BPP 108, 109 ensures that electrons are able to travel across the active layer 126 in order to ensure the electrochemical reaction to generate electricity occurs effectively. Similarly, the contact and compression between land-GDL-MEA-GDL-land, which may be on the other side of the electrical resistance, also requires contact maintenance.

Contact maintenance may occur through any means. An illustrative example of contact maintenance is via welding, and may occur at any location on the fuel cell 100, such as at the channels or flow fields 120, 122. Specifically, contact maintenance at the bottom of the channels or flow fields 120, 122 is important as it is often used as in welding to aid in assembly of the fuel cell 100 and/or is important for electrical continuity of the overall fuel cell stack.

In an embodiment, changing the depth of the anode and cathode channels or flow fields 120, 122 may have no or minimal impact on the resulting coolant channel 124 geometry. In other embodiments, the height and/or geometry of the coolant flow fields 124 are reduced or increased by the same or similar height as the anode and cathode channels or flow fields 120, 122. In other embodiments, the height and/or geometry of the coolant flow fields 124 are reduced or increased by a different height as the anode and cathode channels or flow fields 120, 122.

For example, in an embodiment, the reactant flow channel or flow fields 120, 122, 124 geometry may have a standard height, depth, and/or width ranging from about 0.05 to about 0.5 mm high, including any length or range of length comprised therein. In another embodiment, the reactant flow channel or flow fields 120, 122, 124 geometry may have a standard height, depth, and/or width ranging from about 0.2 mm to about 0.6 mm, including any length or range of length comprised therein. In an embodiment, the reactant flow channel or flow fields 120, 122, 124 may have dimensions of about 0.3 mm in height or depth by about 0.5 mm wide. In some embodiments, the reactant flow channel or flow fields 120, 122, 124 may have a slight draft angle.

In some embodiments, the reactant and coolant flow fields 120, 122, 124 may have a constant flow region 202 since the length of the channels may be extended to accommodate for the reduced height or depth. The length of a standard reactant flow channel or flow fields 120, 122, 124 over a fuel cell stack typically may range from about 200 mm to about 300 mm, including any length or range of length comprised therein. In some other embodiments, the length of reactant flow channel or flow fields 120, 122, 124 may be increased by about 50% to about 100%, including any specific or range of percentages comprised therein.

In an embodiment, for any given active area 126, a fuel cell 100 and/or fuel cell stack may be designed with any combination of length and width to achieve the required and/or target active area 126. In some embodiments, changing the depth of the anode and cathode channels or flow fields 120, 122 may support and/or produce flow field channels 120, 122 for the reactants 110, 112 and/or coolant that have a longer or extended length beyond the standard length. The longer flow field channels 120, 122 may act to support a larger active areas 126. In other embodiments, the presence of a design consideration, such as the geometry of the channels or flow fields 120, 122, which can be varied, may enable the development of a system that can support a large active area 126. Such a system may be useful in the commercial vehicle or industrial space where large active areas 126 of a fuel cell 100 and/or fuel cell stack are required to produce enough electricity to power the application.

In an embodiment, the anode and cathode channels or flow fields 120, 122 may be closely nested together and the BPP 108, 109 may have a more compact or decreased size. For example, if the inlet channel or flow field depth is left unchanged, and the exit or outlet area is reduced by 40%, then the channels or flow fields 120, 122 of the bipolar plate BPP 108, 109 portion of the fuel cell 100 may see a reduction of approximately 20% in size. The combination of the GDL 104, 106 and the MEA 102 of the fuel cell 100 may account for roughly half of the length of the repeating unit 128. Consequently, about 40% reduction in height of the channel or flow field 120, 122 at the exit may result in about 10% reduction in the size of the repeating unit 128. Thus, about a 10% reduction in the overall size of the fuel cell 100 or fuel cell stack volume comprising many repeating units 128 may result.

In some embodiments, the height of channels or flow fields 120, 122 of the BPP 108, 109 may be reduced by about 20% to about 30% or by about 30% to about 40%, including any specific or range of percentage comprised therein. In other embodiments, the overall size of the fuel cell 100 or fuel cell stack volume comprising many repeating units 128 may be reduced by about 5% to about 10%, including any specific or range of percentage of comprised therein.

In an embodiment, an increase in pressure drop may be enforced mechanically by altering the depth of the channels or flow fields 120, 122. In some embodiments, the increase in flow field pressure drop may balance the plate-to-plate gas distribution between consecutive BPPs 108, 109. Altering the depth of the channels or flow fields 120, 122 may increase the pressure drop by about 50% to about 60%, by about 60% to about 70%, by about 70% to about 80%, by about 80% to about 90%, by about 90% to about 100%, including any specific percentage or range of percentage comprised therein.

In an embodiment, accumulation of water may cause flooding in the fuel cell 100 and/or fuel cell stack resulting in a cascading effect that prevents a channel or flow field 120, 122 from exhausting, clearing, and/or unblocking. In other embodiments, when a single channel or flow field 120, 122 becomes blocked, such as with water, debris or residue, reactants 110, 112 may begin to bias the flow to adjacent channels or flow fields 120, 122 comprising no such obstructions.

In an embodiment, the altered channels or flow fields 120, 122 geometry may cause an increase in the pressure drop across a given channel or flow field 120, 122 due to a decrease in height across a given channel or flow field 120, 122. In some embodiments, the increase in pressure drop across channels or flow fields 120, 122 may prevent reactant flow from easily circumventing the blocked channels or flow fields 120, 122. In some embodiments, the increase in pressure drop across channels or flow fields 120, 122 may help in preventing blockage a scenario where the non-inclined channel would have resulted in a blocked channel or flooded flow field 120, 122.

In an embodiment, a reduced exit channel or flow field 120, 122 depth may unblock or mitigate channel or flow field 120, 122 blocking due to water accumulation. The increase in fluid velocity may provide an increase in a pushing effect within the narrowed channels or flow fields 120, 122 comprising any such blockages, obstructions, or reduced flow area/volume. This pushing or jetting effect may be advantageous in fuel cell operation because the pushing or jetting of reactant fluids through the flow fields 120, 122 may aid in removing accumulated water.

More specifically, decreasing the flow region 202 that the reactants 110, 112 travel through, typically with a constant volumetric flow, may increase the velocity of the reactant, both the fuel and oxidant flow. This concentration or “squeezing” of the reactant flow into a smaller flow region 202 results in an advantageous jetting effect where the velocity of the reactant flow substantially increases. Jetting enhances surface water film transport, which may produced as a by-product of the electrochemical reaction occurring at the MEA, and if left stagnant is harmful and damaging to the fuel cell 100 to be effectively and expeditiously removed.

The increased velocity of the reactant flow exiting the BPP 108, 109 due to the declination and/or inclination of the height (e.g., depth) of the flow region 202 results in an advantageously rapid, thorough, and efficient mechanism to manage and/or remove water from the fuel cell 100. Doing so enables the life and performance of the fuel cell 100 to be increased, maintained, and/or extended. While this jetting benefit may or may not be observed with multiple types of materials used for the BPP 108, 109 it is particularly noted and observed for a metal BPP 108, 109 having a change of height (not a change of width) in the planar deflection of reactant channels or flow fields 120, 122.

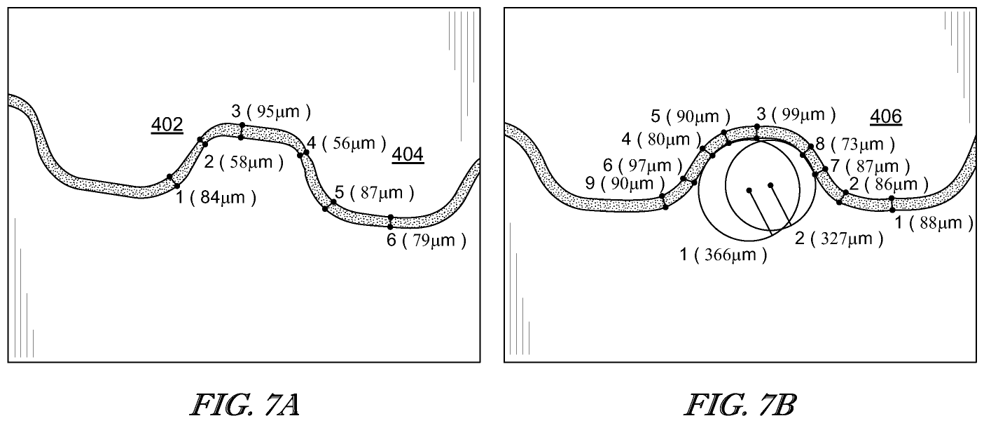

In an embodiment, the BPP 108, 109 may be required to be electrically conductive especially in the active area 126. Deformed, bent, or elongated metal may suffer from an increase in electrical resistance due to deformations or bends that imposes stretch effects within the crystal structure as shown in FIG. 7A and FIG. 7B. This stretching of the metal causes microfractures or discontinuities within the metal structure which increases electrical resistance. Any increase in electrical resistance adversely effects the fuel cell and/or fuel cell stack 400 performance. For example, metal deformation due to stretch affects of a bend radius, such as is shown at the top shoulders 402/404/406 of the BPP 108, 109, reduces the electrical conductivity of the BPP 108, 109.

However, in a present embodiment, incorporating a reduced channel or flow field 120, 122 depth may result in a decrease in stretch or strain on the metal material of the channel or flow field 120, 122. Consequently, a decrease in the electrical resistance of the channel or flow field 120, 122 and therefore, a reduction of resistance losses (e.g., as measured in ohms) is observed. Thus, reducing the channel or flow field 120, 122 depth and/or using a symmetrical geometry with less average deformation may increase fuel cell and/or fuel cell stack 400 performance due to reduced ohmic losses in the fuel cell and/or fuel cell stack 400.

In some embodiments, the geometry of the channel or flow field 120, 122 may be altered by altering the depth of the channel or flow field 120, 122 in a multi-component stamped plate assembly. In other embodiments, the geometry of the channel or flow field 120, 122 may be altered by altering the depth of the channel or flow field 120, 122 by etching, milling, or embossing the channel or flow field 120, 122. In a further embodiment, the geometry of the channel or flow field 120, 122 may be altered by altering the depth of the channel or flow field 120, 122 by a method that does not comprise etching, milling, or embossing the channel or flow field 120, 122.

In an embodiment, altering the geometry of the channel or flow field 120, 122 by altering the depth of the channel or flow field 120, 122 may optimize reactant exposure time. In some embodiments, altering the geometry of the channel or flow field 120, 122 by altering the depth of the channel or flow fields 120, 122 may increase inertial forces within the reactant channels or flow fields 120, 122 and avoid water accumulation. In some other embodiments, the water accumulation in the reactant channels or flow fields 120, 122 may be avoided with minimal pumping and/or system parasitic losses.

In an embodiment, a method of reducing water accumulation in the channel or flow field 120, 122 in a fuel cell and/or fuel cell stack 100 includes altering the geometry of the channel or flow field 120, 122, and passing the reactants 110, 112 through the altered geometry of the channel or flow field 120, 122. In an embodiment, a method of increasing the diffusion of the reactants 110, 112 in the active area 126 of a fuel cell and/or fuel cell stack 100 includes altering the geometry of the channel or flow field 120, 122 and passing the reactants 110, 112 through the altered geometry of the channel or flow field 120, 122. In some embodiments, altering the geometry of the channel or flow field 120, 122 may include decreasing the depth with or without altering the width of the channel or flow field 120, 122. In some embodiments, decreasing the depth and/or the width of the channel or flow field 120, 122 may occur along the direction of reactant flow or opposite the direction of reactant flow.

The following numbered embodiments are contemplated and non-limiting:

1. A fuel cell stack comprising: a membrane electrode assembly (MEA), a gas diffusion layer (GDL) on a first side of the MEA, and a metal bipolar plate (BPP) comprising more than one anode channels and more than one cathode channels next to GDL, wherein a fuel flows through the more than one anode channels and an oxidant flows through the more than one cathode channels, and wherein a depth of the more than one anode channels or more than one cathode channels changes along a length of the fuel cell or fuel cell stack.
2. A method of operating a fuel cell stack comprising: operating a plurality of fuel cells comprising a membrane electrode assembly (MEA), a gas diffusion layer (GDL) on a first side of the MEA, and a metal bipolar plate (BPP), wherein the metal BPP is configured to be next to the GDL that is configured to be next to the MEA, flowing a fuel through more than one anode channels and an oxidant through more than one cathode channels of the metal BPP, and decreasing water accumulation in the more than one anode channels or more than one cathode channels, wherein a depth of the more than one anode channels or more than one cathode channels changes along a length of the fuel cell stack.
3. The fuel cell or the method of operating the fuel cell stack of clauses 1 and/or 2, or any combination of suitable clauses, wherein the fuel cell comprises the fuel cell stack, the plurality of fuel cells, and/or one or more fuel cells.
4. The fuel cell or the method of operating the fuel cell stack of clauses 1 and/or 2, or any combination of suitable clauses, wherein the fuel cell comprises a repeating unit.
5. The fuel cell or the method of operating the fuel cell stack of clause 3, or any combination of suitable clauses, wherein the repeating unit comprises a single MEA, one or more GDLs on one or both sides of the single MEA, and/or a BPP.
6. The fuel cell or the method of operating the fuel cell stack of clauses 1 and/or 2, or any combination of suitable clauses, wherein the fuel cell and/or the fuel cell stack has an inlet header and/or an outlet header to establish one or more header regions.
7. The fuel cell or the method of operating the fuel cell stack of clauses 1 and/or 2, or any combination of suitable clauses, wherein the fuel cell and/or the fuel cell stack comprises an active area.
8. The fuel cell or the method of operating the fuel cell stack of clause 7, or any combination of suitable clauses, wherein the active area is a reacting site.
9. The fuel cell or the method of operating the fuel cell stack of clause 7, or any combination of suitable clauses, wherein the active area is where electrochemical reactions occur to generate power produced by the fuel cell.
10. The fuel cell or the method of operating the fuel cell stack of clause 7, or any combination of suitable clauses, wherein the active area is centered within the GDL and the BPP.
11. The fuel cell or the method of operating the fuel cell stack of clause 7, or any combination of suitable clauses, wherein the active area has a lead-in and/or header region before and/or after the MEA.
12. The fuel cell or the method of operating the fuel cell stack of clause 11, or any combination of suitable clauses, wherein the header region ensures better distribution over the MEA.
13. The fuel cell or the method of operating the fuel cell stack of clause 7, or any combination of suitable clauses, wherein the active area is the area where the MEA resides within each repeating unit.
14. The fuel cell or the method of operating the fuel cell stack of clauses 1 and/or 2, or any combination of suitable clauses, wherein the plurality of fuel cells
15. The fuel cell or the method of operating the fuel cell stack of clauses 1 and/or 2, or any combination of suitable clauses, wherein the MEA and/or the GDL impact the power rating of the fuel cell and/or the fuel cell stack.
16. The fuel cell or the method of operating the fuel cell stack of clauses 1 and/or 2, or any combination of suitable clauses, wherein the MEA is fed excess fuel and/or oxidant to ensure adequate reactant supply over the entire active area and/or wherein excess fuel and/or oxidant is removed from the active area.
17. The fuel cell or the method of operating the fuel cell stack of clauses 1 and/or 2, or any combination of suitable clauses, wherein the first side is an anode side and/or a cathode side of the MEA.
18. The fuel cell or the method of operating the fuel cell stack of clauses 1 and/or 2, or any combination of suitable clauses, wherein the GDL is hydrophobic.
19. The fuel cell or the method of operating the fuel cell stack of clauses 1 and/or 2, or any combination of suitable clauses, wherein the metal BPP is hydrophilic.
20. The fuel cell or the method of operating the fuel cell stack of clauses 1 and/or 2, or any combination of suitable clauses, wherein the GDL repels liquid water when liquid water begins to form over the active area so the liquid water is attracted to the metal BPP surface.
21. The fuel cell or the method of operating the fuel cell stack of clause 20, or any combination of suitable clauses, wherein the liquid water is pushed by the incoming oxidant towards the exit and/or is ejected out of the fuel cell and/or the fuel cell stack.
22. The fuel cell or the method of operating the fuel cell stack of clause 20, or any combination of suitable clauses, wherein the liquid water is generated faster than the oxidant is able to expel the liquid water toward the fuel cell and/or the fuel cell stack exit.
23. The fuel cell or the method of operating the fuel cell stack of clauses 1 and/or 2, or any combination of suitable clauses, wherein the metal BPP is responsible for uniformly distributing reactants to the active area of each fuel cell through oxidant flow fields and or/fuel flow field, is responsible for isolating or sealing the reactants within their respective pathways while being electrically conductive and/or robust, and/or is responsible for effectively removing any products and remaining reactants from the active area.
24. The fuel cell or the method of operating the fuel cell stack of clauses 1 and/or 2, or any combination of suitable clauses, wherein the more than one anode channels are more than one anode flow fields and/or more than one fuel flow fields.
25. The fuel cell or the method of operating the fuel cell stack of clauses 1 and/or 2, or any combination of suitable clauses, wherein the depth of the more than one anode channels changes in a direction of the flow of the fuel or against the direction of the flow of the fuel.
26. The fuel cell or the method of operating the fuel cell stack of clauses 1 and/or 2, or any combination of suitable clauses, wherein the depth of the more than one anode channels is inclined towards the MEA.
27. The fuel cell or the method of operating the fuel cell stack of clauses 1 and/or 2, or any combination of suitable clauses, wherein the depth of the more than one anode channels is inclined by using one or more shims, standoffs, or spacers.
28. The fuel cell or the method of operating the fuel cell stack of clauses 1 and/or 2, or any combination of suitable clauses, wherein the more than one cathode channels are more than one cathode flow fields and/or more than one oxidant flow fields.
29. The fuel cell or the method of operating the fuel cell stack of clauses 1 and/or 2, or any combination of suitable clauses, wherein the more than one anode channels and/or the more than one cathode channels have a change in geometry to allow and/or enable localized fluid acceleration to better mitigate probable water accumulation.
30. The fuel cell or the method of operating the fuel cell stack of clause 29, or any combination of suitable clauses, wherein the change in geometry is achieved by decreasing the width of the more than one anode channels and/or the more than one cathode channels, and/or by decreasing the height and/or depth of the more than one anode channels and/or the more than one cathode channels.
31. The fuel cell or the method of operating the fuel cell stack of clauses 1 and/or 2, or any combination of suitable clauses, wherein the depth of the more than one cathode channels changes in a direction in the flow of the oxidant or against the direction of the flow of the oxidant.
32. The fuel cell or the method of operating the fuel cell stack of clauses 1 and/or 2, or any combination of suitable clauses, wherein the depth of the more than one cathode channels is inclined towards the MEA.
33. The fuel cell or the method of operating the fuel cell stack of clauses 1 and/or 2, or any combination of suitable clauses, wherein the depth of the more than one cathode channels is inclined by using one or more shims, standoffs, or spacers.
34. The fuel cell or the method of operating the fuel cell stack of clauses 1 and/or 2, or any combination of suitable clauses, wherein the sum of the depth of the more than one anode channels and the corresponding depth of the more than one cathode channels is constant across the fuel cell and/or the fuel cell stack.
35. The fuel cell or the method of operating the fuel cell stack of clauses 1 and/or 2, or any combination of suitable clauses, wherein the fuel is supplied to the fuel cell and/or the fuel cell stack at the anode.
36. The fuel cell or the method of operating the fuel cell stack of clauses 1 and/or 2, or any combination of suitable clauses, wherein the fuel is supplied to the fuel cell and/or the fuel cell stack to provide the necessary reactant to generate power.
37. The fuel cell or the method of operating the fuel cell stack of clauses 1 and/or 2, or any combination of suitable clauses, wherein the fuel is hydrogen.
38. The fuel cell or the method of operating the fuel cell stack of clauses 1 and/or 2, or any combination of suitable clauses, wherein the fuel in the fuel cell and/or the fuel cell stack is subject to a chemical reaction on the anode side of the MEA.
39. The fuel cell or the method of operating the fuel cell stack of clause 38, or any combination of suitable clauses, wherein the chemical reaction of the fuel on the anode side is represented as: λₐₙH₂→(λₐₙ−1)H₂.
40. The fuel cell or the method of operating the fuel cell stack of clauses 1 and/or 2, or any combination of suitable clauses, wherein the oxidant is atmospheric air, oxygen and/or humidified air.
41. The fuel cell or the method of operating the fuel cell stack of clauses 1 and/or 2, or any combination of suitable clauses, wherein the oxidant in the fuel cell and/or fuel cell stack is subject to a chemical reaction on the cathode side of the MEA.
42. The fuel cell or the method of operating the fuel cell stack of clause 41, or any combination of suitable clauses, wherein the chemical reaction of the oxidant on the cathode side is represented as: 2H₂+λ_{ca}(O₂+(1/C_{O2}−1)N₂)←→2H₂O+(λ_{ca}−1)(O₂+λ_{ca}(1/C_{O2}−1)N₂).
43. The fuel cell or the method of operating the fuel cell stack of clauses 1 and/or 2, or any combination of suitable clauses, wherein the fuel and/or the oxidant are reactants.
44. The fuel cell or the method of operating the fuel cell stack of clauses 1 and/or 2, or any combination of suitable clauses, wherein the reactants have a flow that has a velocity.
45. The fuel cell or the method of operating the fuel cell stack of clause 44, or any combination of suitable clauses, wherein the velocity of the flow varies with a cross-sectional area of the more than one anode channels and/or the more than one cathode channels.
46. The fuel cell or the method of operating the fuel cell stack of clause 44, or any combination of suitable clauses, wherein the velocity of the flow is locally increased by reducing the size of the more than one anode channels and/or the more than one cathode channels in the direction of the flow.
47. The fuel cell or the method of operating the fuel cell stack of clauses 1 and/or 2, or any combination of suitable clauses, wherein the reactants have a change in composition as they flow across the active area.
48. The fuel cell or the method of operating the fuel cell stack of clauses 1 and/or 2, or any combination of suitable clauses, wherein the metal BPP accounts for the change in composition in the reactants.
49. The fuel cell or the method of operating the fuel cell stack of clauses 1 and/or 2, or any combination of suitable clauses, wherein the metal BPP has an increased ability to transport reacting molecules of the reactants from, across, and/or over the active area away from the MEA after the chemical reaction has taken place.
50. The fuel cell or the method of operating the fuel cell stack of clauses 1 and/or 2, or any combination of suitable clauses, wherein the metal BPP provides mechanical support to prevent the fuel cell and/or the fuel cell stack from bursting when pressurized, provides rigidity for compressing and/or sealing the fuel cell and/or the fuel cell stack, and/or provides an inherent and/or intrinsic seal of the fuel cell and/or the fuel cell stack.
51. The fuel cell or the method of operating the fuel cell stack of clause 50, or any combination of suitable clauses, wherein the inherent and/or intrinsic seal comprises one or more external seals comprised by the fuel cell and/or the fuel cell stack.
52. The fuel cell or the method of operating the fuel cell stack of clause 50, or any combination of suitable clauses, wherein the inherent and/or intrinsic seal isolates the oxidant, the fuel, and/or cooling fluids to their respective more than one cathode channels, more than one anode channels, and/or cooling fluid flow fields, and/or prevents external leakage of the oxidant, the fuel, and/or the cooling fluids.
53. The fuel cell or the method of operating the fuel cell stack of clause 52, or any combination of suitable clauses, wherein the cooling fluids are coolants, and/or wherein the cooling fluid flow fields are coolant flow fields and/or coolant channels.
54. The fuel cell or the method of operating the fuel cell stack of clause 52, or any combination of suitable clauses, wherein the cooling fluid flow fields are positioned between the more than one cathode channels and the more than one anode channels.
55. The fuel cell or the method of operating the fuel cell stack of clause 52, or any combination of suitable clauses, wherein the more than one cathode channels, the more than one anode channels, and the cooling fluid flow fields are parallel and/or non-parallel to each other.
56. The fuel cell or the method of operating the fuel cell stack of clauses 1 and/or 2, or any combination of suitable clauses, wherein the fuel cell and/or the fuel cell stack comprises one or more, many, multiple, or a plurality of the more than one cathode channels, the more than one anode channels, and the cooling fluid flow fields.
57. The fuel cell or the method of operating the fuel cell stack of clauses 1 and/or 2, or any combination of suitable clauses, wherein the metal BPP houses a network of the more than one cathode channels, the more than one anode channels, and the cooling fluid flow fields that consists of about 10 to about 100 of the more than one cathode channels, the more than one anode channels, and/or the cooling fluid flow, comprising any number or range of flow fields comprised therein.
58. The fuel cell or the method of operating the fuel cell stack of clauses 1 and/or 2, or any combination of suitable clauses, wherein the metal BPP comprises any number of sheets, including one, two, or more sheets.
59. The fuel cell or the method of operating the fuel cell stack of clause 58, or any combination of suitable clauses, wherein each sheet comprises a material.
60. The fuel cell or the method of operating the fuel cell stack of clause 59, or any combination of suitable clauses, wherein the material is any electrically conductive material, metal, graphite, and/or any similar or different powder-based product that is prepared by an impregnation or solidifying process.
61. The fuel cell or the method of operating the fuel cell stack of clause 61, or any combination of suitable clauses, wherein the metal is any type of electrically conductive metal, steel, iron, nickel, aluminum, and/or titanium, or combinations thereof.
62. The fuel cell or the method of operating the fuel cell stack of clause 62, or any combination of suitable clauses, wherein the steel is austenitic stainless steel (304L, 316L, 904L, and/or 310S) and/or ferritic stainless steel (430, 441, 444, and/or Crofer).
63. The fuel cell or the method of operating the fuel cell stack of clause 62, or any combination of suitable clauses, wherein the nickel is nickel based alloys (200/201, 286, 600, and/or 625).
64. The fuel cell or the method of operating the fuel cell stack of clause 62, or any combination of suitable clauses, wherein the titanium is Grade 1 and/or Grade 2 titanium.
65. The fuel cell or the method of operating the fuel cell stack of clause 62, or any combination of suitable clauses, wherein the aluminum is 1000 series and/or 3000 series.
66. The fuel cell or the method of operating the fuel cell stack of clause 58, or any combination of suitable clauses, wherein at least two sheets of the metal BPP are sealed, welded, stamped, structured, bonded, and/or configured to provide the more than one cathode channels, the more than one anode channels, and/or the cooling fluid flow fields for the reactants and/or the cooling fluid.
67. The fuel cell or the method of operating the fuel cell stack of clause 58, or any combination of suitable clauses, wherein the sheets of the metal BPP comprise a first sheet and/or a second sheet.
68. The fuel cell or the method of operating the fuel cell stack of clause 67, or any combination of suitable clauses, wherein the first sheet comprises indentations to produce the more than one anode channels and/or the more than one cathode channels.
69. The fuel cell or the method of operating the fuel cell stack of clause 67, or any combination of suitable clauses, wherein the second sheet has a similar construction to the first sheet with an opposite reactant port.
70. The fuel cell or the method of operating the fuel cell stack of clause 67, or any combination of suitable clauses, wherein the second sheet is sealed, welded, affixed, bolted, and/or bonded to the first sheet.
71. The fuel cell or the method of operating the fuel cell stack of clause 67, or any combination of suitable clauses, wherein the first sheet has fuel or oxidant enter a port and/or a header from the top right and exit from the bottom left.
72. The fuel cell or the method of operating the fuel cell stack of clause 67, or any combination of suitable clauses, wherein the second sheet has fuel or oxidant enter a port and/or a header from the top left and exit from the bottom right.
73. The fuel cell or the method of operating the fuel cell stack of clause 58, or any combination of suitable clauses, wherein at least one sheet of the metal BPP comprises indentations to produce the more than one anode channels and/or the more than one cathode channels, one or more header regions, an inlet header region and/or an outlet header region.
74. The fuel cell or the method of operating the fuel cell stack of clause 73, or any combination of suitable clauses, wherein the outlet header region is an exhaust header region.
75. The fuel cell or the method of operating the fuel cell stack of clause 58, or any combination of suitable clauses, wherein at least one sheet of the metal BP comprises about 2 to about 6 ports or manifolds, including any number or range of ports or manifolds comprised therein.
76. The fuel cell or the method of operating the fuel cell stack of clause 75, or any combination of suitable clauses, wherein the ports or manifolds include an individual inlet port and/or an exhaust port for the fuel, the oxidant, and/or the cooling fluid.
77. The fuel cell or the method of operating the fuel cell stack of clause 75, or any combination of suitable clauses, wherein at least two of the ports or manifolds is surrounded by a gasket or solid gasket to form one set of sealed ports or manifolds with enhanced strength.
78. The fuel cell or the method of operating the fuel cell stack of clause 58, or any combination of suitable clauses, wherein the sheets are designed, prepared, and/or manufactured in a way that results in a parallel array of corrugated anode channels, cathode channels and/or cooling fluid flow fields with one or more walls and an open face.
79. The fuel cell or the method of operating the fuel cell stack of clauses 1 and/or 2, or any combination of suitable clauses, wherein the metal BPP comprises about 20% to about 100% metal, including any percentage or range of percentages of metal comprised therein.
80. The fuel cell or the method of operating the fuel cell stack of clauses 1 and/or 2, or any combination of suitable clauses, wherein the metal BPP acts both as the anode and the cathode of two neighboring fuel cells of the fuel cell stack.
81. The fuel cell or the method of operating the fuel cell stack of clauses 1 and/or 2, or any combination of suitable clauses, wherein the more than one anode channels, the more than one cathode channels, and/or the cooling fluid flow fields comprise three walls and an open face.
82. The fuel cell or the method of operating the fuel cell stack of clause 81, or any combination of suitable clauses, wherein the three walls and open face of each of the more than one cathode channels, and/or the cooling fluid flow fields forms peaks and troughs.
83. The fuel cell or the method of operating the fuel cell stack of clause 82, or any combination of suitable clauses, wherein the peaks are the high or raised portions of the more than one cathode channels, and/or the cooling fluid flow fields.
84. The fuel cell or the method of operating the fuel cell stack of clause 82, or any combination of suitable clauses, wherein the troughs are the low or lowered portions of the more than one cathode channels, and/or the cooling fluid flow fields.
85. The fuel cell or the method of operating the fuel cell stack of clauses 1 and/or 2, or any combination of suitable clauses, wherein a cooling fluid flow field of the cooling fluid flow fields is aligned next to an anode channel of the more than one anode channels.
86. The fuel cell or the method of operating the fuel cell stack of clause 85, or any combination of suitable clauses, wherein the cooling fluid flow field comprises one half-channel of the cooling fluid flow field and one half coolant volume of one repeating unit.
87. The fuel cell or the method of operating the fuel cell stack of clause 85, or any combination of suitable clauses, wherein the cooling fluid flow field comprises a second half-channel of the cooling fluid flow field and a second half coolant volume of one repeating unit, and wherein the second half-channel of the cooling fluid flow field and the second half coolant volume of one repeating unit is aligned with a cathode channel of the more than one cathode channels.
88. The fuel cell or the method of operating the fuel cell stack of clause 85, or any combination of suitable clauses, wherein the one half-channel and the second half-channel comprise the entire cooling fluid flow field.
89. The fuel cell or the method of operating the fuel cell stack of clause 85, or any combination of suitable clauses, wherein the cooling fluid flow field comprises a volume that is not utilized by the more than one anode channels and/or the more than one cathode channels.
90. The fuel cell or the method of operating the fuel cell stack of clauses 1 and/or 2, or any combination of suitable clauses, wherein the more than one cathode channels are configured to be similar to the more than one anode channels with or without structural differences to account for oxidant handling rather than fuel handling.
91. The fuel cell or the method of operating the fuel cell stack of clauses 1 and/or 2, or any combination of suitable clauses, wherein the reactants and/or the coolant flow in an inline configuration, in approximately straight lines, in approximately parallel lines, in a constantly crossed configuration, and/or in a zig-zagged configuration
92. The fuel cell or the method of operating the fuel cell stack of clause 91, or any combination of suitable clauses, wherein the crossed configuration causes the reactants and/or the coolant to cross each other in any angle lower than a 90 degree angle.
93. The fuel cell or the method of operating the fuel cell stack of clause 91, or any combination of suitable clauses, wherein the zig-zagged configuration causes the reactants and/or the coolant to cross over each other multiple times.
94. The fuel cell or the method of operating the fuel cell stack of clause 91, or any combination of suitable clauses, wherein a first reactant flows in an approximately straight line and wherein a second reactant crosses over the first reactant multiple times.
95. The fuel cell or the method of operating the fuel cell stack of clauses 1 and/or 2, or any combination of suitable clauses, wherein the more than one anode channels, the more than one cathode channels, and/or the cooling fluid flow fields comprise a flow region.
96. The fuel cell or the method of operating the fuel cell stack of clause 95, or any combination of suitable clauses, wherein the flow region is a space, area, and/or volume in each channel or flow field where the oxidant, the fuel, or the coolant flow through the metal BPP.
97. The fuel cell or the method of operating the fuel cell stack of clause 95, or any combination of suitable clauses, wherein the flow region of each of the more than one anode channels and the more than one cathode channels are parallel to each other.
98. The fuel cell or the method of operating the fuel cell stack of clause 95, or any combination of suitable clauses, wherein the flow region of each of the more than on anode channels and the more than one cathode channels is configured to include an inclination or declination between at least two sheets of the metal BPP.
99. The fuel cell or the method of operating the fuel cell stack of clause 98, or any combination of suitable clauses, wherein the inclination or declination is on a plane of the peak of one anode and/or cathode channel on a first sheet of the metal BPP and one a plane of the peak of one anode and/or cathode channel on a second sheet of the metal BPP.
100. The fuel cell or the method of operating the fuel cell stack of clause 99, or any combination of suitable clauses, wherein the first sheet and the second sheet are configured together at a structure within a plane or a structural plane to form the more than one anode channels and/or the more than one cathode channels.
101. The fuel cell or the method of operating the fuel cell stack of clause 100, or any combination of suitable clauses, wherein the structural plane has an inclination or declination.
102. The fuel cell or the method of operating the fuel cell stack of clause 100, or any combination of suitable clauses, wherein the angle and/or depth of the inclination or declination of the structural plane is identical and opposite to the angle and/or depth of the inclination or declination of the flow region.
103. The fuel cell or the method of operating the fuel cell stack of clauses 1 and/or 2, or any combination of suitable clauses, wherein each of the more than one anode channels and/or the more than one cathode channels that include the structural plane further comprise a change in the height and/or depth of the flow region.
104. The fuel cell or the method of operating the fuel cell stack of clause 101, or any combination of suitable clauses, wherein the change in the height and/or depth of the flow region is constant or not constant, declines and/or decreases the flow region in the same direction of the reactant flow, and/or declines and/or decreases the flow region from an inlet toward an outlet.
105. The fuel cell or the method of operating the fuel cell stack of clause 101, or any combination of suitable clauses, wherein the change in the height and/or depth of the flow region results in a decrease in the flow region and an increase in the flow velocity of the reactant(s).
106. The fuel cell or the method of operating the fuel cell stack of clause 101, or any combination of suitable clauses, wherein each of the more than one anode channels and/or the more than one cathode channels are inclined towards the structural plane where the first sheet and the second sheet are configured together.
107. The fuel cell or the method of operating the fuel cell stack of clause 101, or any combination of suitable clauses, wherein the inclination in at least one of the more than one anode channels and/or the more than one cathode channels narrows and/or widens at least one of the more than one anode channels and/or the more than one cathode channels.
108. The fuel cell or the method of operating the fuel cell stack of clauses 1 and/or 2, or any combination of suitable clauses, wherein the change in geometry of the more than one anode channels and/or the more than one cathode channels is achieved with an equal and opposite planar deflection on both the more than one anode channels and the more than one cathode channels.
109. The fuel cell or the method of operating the fuel cell stack of clauses 1 and/or 2, or any combination of suitable clauses, wherein the planar declination and/or inclination of the structural plane of the flow region and/or the more than one cathode channels and the more than one anode channels is a linear, parabolic, periodic, logarithmic, and/or sinusoidal relationship.
110. The fuel cell or the method of operating the fuel cell stack of clauses 1 and/or 2, or any combination of suitable clauses, wherein the more than one anode channels and/or the more than one cathode channels of one metal BPP are paired with the exact feature on an opposite metal BPP.
111. The fuel cell or the method of operating the fuel cell stack of clauses 1 and/or 2, or any combination of suitable clauses, wherein the anode side and/or the cathode side across the metal BPP comprises a planar declination and/or inclination of the flow region of the more than one anode channels and the more than one anode channels and has a total height that is retained and/or constant.
112. The fuel cell or the method of operating the fuel cell stack of clause 111, or any combination of suitable clauses, wherein the constant height of the anode side and/or the cathode side allows contact to be maintained and/or contact maintenance between the bottoms of the more than one anode channels and the more than one cathode channels in the metal BPP with the GDL.
113. The fuel cell or the method of operating the fuel cell stack of clauses 1 and/or 2, or any combination of suitable clauses, wherein the material of the metal BPP has sufficient strength and rigidity to enable contact maintenance to ensure minimal contact resistance and adequate GDL compression to support the electrochemical reaction of the fuel cell for generating power efficiently.
114. The fuel cell or the method of operating the fuel cell stack of clauses 1 and/or 2, or any combination of suitable clauses, wherein the contact maintenance occurs through welding and/or occurs at any location on the fuel cell and/or at the bottoms of the more than one anode channels and the more than one cathode channels.
115. The fuel cell or the method of operating the fuel cell stack of clauses 1 and/or 2, or any combination of suitable clauses, wherein the cooling fluid flow fields are reduced or increased by a different, the same or similar height as the more than one anode channels and/or the more than one cathode channels.
116. The fuel cell or the method of operating the fuel cell stack of clauses 1 and/or 2, or any combination of suitable clauses, wherein the more than one anode channel, the more than one cathode channels, and/or the cooling fluid flow fields have a standard height, depth, and/or width ranging from about 0.05 mm to about 0.6 mm, including any length or range of length comprised therein.
117. The fuel cell or the method of operating the fuel cell stack of clauses 1 and/or 2, or any combination of suitable clauses, wherein the more than one anode channel, the more than one cathode channels, and/or the cooling fluid flow fields have a constant flow region.
118. The fuel cell or the method of operating the fuel cell stack of clauses 1 and/or 2, or any combination of suitable clauses, wherein the more than one anode channel, the more than one cathode channels, and/or the cooling fluid flow fields have a length ranging from about 200 mm to about 300 mm.
119. The fuel cell or the method of operating the fuel cell stack of clauses 1 and/or 2, or any combination of suitable clauses, wherein the fuel cell and/or the fuel cell stack is designed with any combination of length and width to achieve the required and/or target active area.
120. The fuel cell or the method of operating the fuel cell stack of clauses 1 and/or 2, or any combination of suitable clauses, wherein the more than one anode channels and the more than one cathode channels are closely nested together and/or the BPP has a more compact or decreased size.
121. The fuel cell or the method of operating the fuel cell stack of clauses 1 and/or 2, or any combination of suitable clauses, wherein the method further comprises operating the fuel cell stack by increasing the diffusion of the fuel and the oxidant at the GDL.
122. The fuel cell or the method of operating the fuel cell stack of clauses 1 and/or 2, or any combination of suitable clauses, wherein the change in depth and/or height of the more than one anode channels and the more than one cathode channels increases a pressure drop in the more than one anode channels and the more than one cathode channels by about 50% to about 100%, including any specific percentage or range of percentage comprised therein.
123. The fuel cell or the method of operating the fuel cell stack of clauses 1 and/or 2, or any combination of suitable clauses, wherein the change in depth, width, length, and/or height of the more than one anode channels and the more than one cathode channels increases the velocity of the reactants and/or causes a jetting effect that enhances surface water film transport.
124. The fuel cell or the method of operating the fuel cell stack of clauses 1 and/or 2, or any combination of suitable clauses, wherein the change in depth, width, length, and/or height of the more than one anode channels and the more than one cathode channels decreases stretch and/or strain on the metal material of the metal BPP and/or reduces resistance losses.
125. The fuel cell or the method of operating the fuel cell stack of clauses 1 and/or 2, or any combination of suitable clauses, wherein the change in depth, width, length, and/or height of the more than one anode channels and the more than one cathode channels is achieved with a multi-component stamped plate assembly, etching, milling, and/or embossing.
126. The fuel cell or the method of operating the fuel cell stack of clauses 1 and/or 2, or any combination of suitable clauses, wherein the change in depth, width, length, and/or height of the more than one anode channels and the more than one cathode channels optimizes reactant exposure time and/or increases inertial forces within the more than one anode channels and/or the more than on cathode channels to avoid water accumulation.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first”, “second”, “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising”, “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances: a possession of a specified property, characteristic or function: and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell comprising:
a membrane electrode assembly,
a gas diffusion layer adjacent a side of the membrane electrode assembly, and
a bipolar plate adjacent the gas diffusion layer, the bipolar plate comprising more than one anode channels, through which a fuel is configured to flow, and more than one cathode channels, through which an oxidant is configured to flow,
wherein a depth of the more than one anode channels or more than one cathode channels changes relative to a structural plane of the more than one anode channels or the more than one cathode channels along a length of the fuel cell.

2. The system of claim 1, wherein the depth is associated with the more than one anode channels, and the depth changes in a direction which is the same direction as the flow of the fuel.

3. The system of claim 1, wherein the depth is associated with the more than one anode channels, and the depth changes opposite a direction of the flow of the fuel.

4. The system of claim 1, wherein the depth is associated with the more than one cathode channels, and the depth changes in a direction which is the same direction as the flow of the oxidant.

5. The system of claim 1, wherein the depth is associated with the more than one cathode channels, and the depth changes against a direction which is the same direction as the flow of the oxidant.

6. The system of claim 1, wherein the depth of the more than one anode channels or the more than one cathode channels is inclined towards a structural plane of the bipolar plate.

7. The system of claim 1, wherein the depth of the more than one anode channels or more than one cathode channels is inclined by using one or more spacers.

8. The system of claim 1, wherein the sum of the depth of the more than one anode channels and the corresponding depth of the more than one cathode channels is constant across the fuel cell.

9. The system of claim 1, wherein the more than one anode channels and the more than one cathode channels are closely nested together so that the geometry of the bipolar plate is compacted.

10. A method of operating a fuel cell stack comprising:
operating a plurality of fuel cells within the fuel cell stack, each fuel cell comprising a membrane electrode assembly, a gas diffusion layer on a side of the membrane electrode assembly, and a bipolar plate, which is configured adjacent to the gas diffusion layer,
flowing a fuel through more than one anode channels and an oxidant through more than one cathode channels of the bipolar plate, and
decreasing water accumulation in the more than one anode channels or more than one cathode channels, wherein a depth of the more than one anode channels or more than one cathode channels changes along a length of the fuel cell stack.

11. The method of claim 10, wherein the method further comprises operating the fuel cell stack by increasing the diffusion of the fuel and the oxidant at the gas diffusion layer.

12. The method of claim 10, wherein the method further comprises changing the depth of the more than one anode channels or the more than one cathode channels relative to a structural plane of the bipolar plate.

13. The method of claim 12, wherein the method further comprises creating a jetting effect that enhances transport of surface water film on the membrane electrode assembly.

14. The method of claim 12, wherein the method further comprises increasing a pressure drop in the more than one anode channels and the more than one cathode channels.

15. The method of claim 14, wherein the pressure drop in the more than one anode channels or the more than one cathode channels drops by 50%-100%.

16. The method of claim 10, wherein the sum of the depth of the more than one anode channels and the corresponding depth of the more than one cathode channels is constant across the fuel cell stack.

17. The method of claim 10, wherein the more than one anode channels and the more than one cathode channels are closely nested together so that the geometry of the bipolar plate is compacted.

18. The method of claim 10, wherein the depth of the more than one anode channels or the more than one cathode channels increases the velocity of the fuel or the oxidant.

19. The method of claim 10, wherein the method further comprises changing the width of the more than one anode channels or the more than one cathode channels relative to a structural plane of the bipolar plate.

20. The method of claim 10, wherein the more than one anode channels or the more than one cathode channels of a first bipolar plate of are paired with the exact feature on a second, opposite bipolar plate.
